(19) United States
(12) Patent Application Publication
(10) Pub. No.: US 2021/0217083 A1
(43) Pub. Date: Jul. 15, 2021

(54) METHOD AND SYSTEM FOR OPTIMIZING RESOURCE REDISTRIBUTION

(71) Applicant: ALIPAY (HANGZHOU) INFORMATION TECHNOLOGY CO., LTD., Hangzhou (CN)

(72) Inventors: Feng QI, HANGZHOU (CN); Xingwen ZHANG, HANGZHOU (CN); Jia YAN, HANGZHOU (CN); Zhigang HUA, HANGZHOU (CN); Shuang YANG, HANGZHOU (CN); Zhen WANG, HANGZHOU (CN); Chen NI, HANGZHOU (CN); Yinchao ZHONG, HANGZHOU (CN); Yanming FANG, HANGZHOU (CN); Quan YU, HANGZHOU (CN)

(21) Appl. No.: 17/218,823

(22) Filed: Mar. 31, 2021

Related U.S. Application Data
(63) Continuation of application No. PCT/CN2020/084511, filed on Apr. 13, 2020.

(51) Int. Cl. G06Q 40/02; G06Q 10/06

(52) U.S. Cl. CPC G06Q 40/025; G06Q 10/0631; G06Q 10/0635

(57) ABSTRACT

Methods, systems, and apparatus, including computer programs encoded on computer storage media, for grouping a plurality of resources into a plurality of cohorts, wherein each of the plurality of resources is associated with a risk level and a benefit level, and resources in each cohort share the same risk level and the same benefit level; obtaining a plurality of provider-level adjustments; constructing an optimization model for determining a resource flow solution; and according to the plurality of cohort-provider-level adjustments, identifying one or more resources in each of the plurality of cohorts that are provided by a first provider to be transferred to a second provider; and automatically sending one or more requests to the first provider and the second provider to transfer the determined one or more first resources from the first provider to the second provider.

### CROSS REFERENCE TO RELATED APPLICATIONS

The application is a continuation application of International Patent Application No. PCT/CN2020/084511, filed on Apr. 13, 2020. The entire content of the above referenced application is incorporated herein by reference.

### TECHNICAL FIELD

The disclosure relates generally to systems and methods for resource redistribution, in particular, for optimizing resource distribution among a plurality of resource providers.

### BACKGROUND

A resource management platform may allow resource owners to provide resources in responses to requests. The resource to be provided may be associated with a negative indicator (e.g., risk, cost) and a positive indicator (e.g., interest, royalty, recurring payments, other types of benefits). It means, when a resource owner serves a resource request (by providing the resource), it receives certain benefits (e.g., interest, payment) but also bears certain risks/costs. Existing resource management platforms allocate the resource requests to the resource owners based on random or greedy algorithms. However, after a certain period of time, these approaches often lead to a scenario where the risk and/or benefit distributions among the resource owners are unbalanced and disproportional. In order to re-balance the risk and/or interest distributions among the resource owners, some resource requests may need to be migrated from one owner to another owner (i.e., making another owner to provide the resource). A resource management platform of a reasonable size may host thousands of resource owners and serve tens of millions of resource requests at the same time, it is almost impractical to use standard optimization technologies to determine which and how the resource requests should be migrated.

### SUMMARY

Various embodiments of the present specification may include systems, methods, and non-transitory computer readable media for optimizing loan distribution.

According to one aspect, a method for optimizing loan distribution is provided. The method may include: grouping a plurality of resources into a plurality of cohorts, wherein each of the plurality of resources is associated with a risk level and a benefit level, and resources in each cohort share the same risk level and the same benefit level; obtaining a plurality of provider-level adjustments respectively corresponding to a plurality of providers providing the plurality of resources, wherein each provider-level adjustment represents a value by which a total amount of resources from the corresponding provider is allowed to be changed; constructing an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and provided by the corresponding provider are to be changed according to the resource flow solution; and according to the plurality of cohort-provider-level adjustments, identifying one or more resources in each of the plurality of cohorts that are provided by a first provider to be transferred to a second provider; and automatically sending one or more requests to the first provider and the second provider to transfer the determined one or more first resources from the first provider to the second provider.

In some embodiments, the method may further comprise: obtaining a global risk distribution and a global benefit distribution, wherein the global risk distribution corresponds to a distribution of the plurality of resources at different risk levels, and the global benefit distribution corresponds to a distribution of the plurality of resources at different benefit levels, and the optimization model comprises: an objective function that minimizes a difference between, for each of the plurality of providers, the corresponding provider-level adjustment and a sum of one or more of the plurality of cohort-provider-level adjustments corresponding to the provider; a first constraint requiring, for a given resource flow solution, a difference between a risk distribution of the provider and the global risk distribution is below a first threshold; and a second constraint requiring, for a given resource flow solution, a difference between a benefit distribution of each provider and the global benefit distribution is below a second threshold.

In some embodiments, the difference between the risk distribution of each provider and the global risk distribution is determined as a Probability Stability Index (PSI), calculated as Σm(pⱼₘ−qₘ) ln pⱼₘ/qₘ, where: m corresponds to a risk level; j corresponds to an identifier corresponding to a provider; pⱼₘ corresponds to a ratio of an amount of jₜₕ provider's resources at risk level m to an amount of the jₜₕ provider's total resources; qₘ corresponds to a ratio of an amount of the plurality of providers' resources at risk level m to an amount of the plurality of resources; and In refers to a natural logarithm.

In some embodiments, the first threshold and the second threshold are identical.

In some embodiments, the optimization model further comprises a third constraint that requires each of the plurality of cohort-provider-level adjustments is within a range, and a fourth constraint that requires a total sum of the plurality of cohort-provider-level adjustments is zero.

In some embodiments, the according to the plurality of cohort-provider-level adjustments, identifying one or more resources in each of the plurality of cohorts that are provided by a first provider to be transferred to a second provider comprises: identifying one or more first resources in a first cohort and provided by a first provider, wherein a total value of the one or more first resources is not greater than a first value associated with a first cohort-provider-level adjustment corresponding to the first cohort and the first provider; and identifying a second provider, wherein a total amount of the one or more first resources is not greater than a second value associated with a second cohort-provider-level adjustment corresponding to the first cohort and the second provider.

In some embodiments, the identifying one or more first resources in a first cohort and provided by a first provider comprises: sorting resources in the first cohort and provided by the first provider; sequentially selecting a maximum number of the sorted resources with a total resource amount not greater than a first value associated with a first cohort-provider-level adjustment corresponding to the first cohort and the first provider; and determining the selected resources as the one or more first resources.

In some embodiments, the first cohort-provider-level adjustment comprises a negative value, indicating an amount of resources to be transferred out of the first provider; and the first value is an absolute value of the negative value.

In some embodiments, the second cohort-provider-level adjustment comprises a positive value, representing an amount of resources to be transferred to the second provider; and the second value is equal to the positive value.

In some embodiments, the grouping a plurality of resources into a plurality of cohorts comprises: grouping the plurality of resources, based on each resource's risk level, into one or more first groups, wherein each of the first groups is associated with a risk level from a set of predetermined risk levels; grouping the plurality of resources, based on each resource's benefit level, into one or more second groups, wherein each of the second groups is associated with a benefit level from a set of predetermined benefit levels; generating the plurality of cohorts respectively corresponding to combinations of the set of predetermined risk levels and the set of predetermined benefit level; and identifying zero or more resources from the plurality of resources to be grouped in each of the plurality of cohorts based on an intersection of the first group associated with the corresponding risk level and the second group associated with the corresponding benefit level.

In some embodiments, the identifying one or more resources in each of the plurality of cohorts that are provided by a first provider to be transferred to a second provider according to the plurality of cohort-provider-level adjustments comprises: creating a plurality of parallelly executable processing threads respectively corresponding to the plurality of cohorts, wherein each of the parallelly executable processing threads executes instructions to determine a resource distribution strategy to redistribute the resources among providers of resources in the corresponding cohort; and parallelly executing the plurality of parallelly executable processing threads

In some embodiments, for each of the plurality of cohorts, the corresponding processing thread performs iterative operations comprising: dividing the plurality of providers into one or more providing providers and one or more receiving providers according to the plurality of cohort-provider-level adjustments; and for each of the receiving providers, iterating the providing providers to collect one or more resources in the cohort to transfer from the providing providers to the receiving provider based on cohort-provider-level adjustments associated with the providing providers and the receiving provider.

According to other embodiments, a system for optimizing resource distribution is configured with instructions executable by the one or more processors to cause the system to perform the method of any of the preceding embodiments.

According to yet other embodiments, a non-transitory computer-readable storage medium is configured with instructions executable by one or more processors to cause the one or more processors to perform the method of any of the preceding embodiments.

According to still other embodiments, an apparatus for optimizing loan distribution comprises a plurality of modules for performing the method of any of the preceding embodiments.

According to another aspect, a system for optimizing loan distribution may comprise a computer system comprising a processor and a non-transitory computer-readable storage medium storing instructions executable by the processor to cause the computer system to perform operations comprising: grouping a plurality of resources into a plurality of cohorts, wherein each of the plurality of resources is associated with a risk level and a benefit level, and resources in each cohort share the same risk level and the same benefit level; obtaining a plurality of provider-level adjustments respectively corresponding to a plurality of providers providing the plurality of resources, wherein each provider-level adjustment represents a value by which a total amount of resources from the corresponding provider is allowed to be changed; constructing an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and provided by the corresponding provider are to be changed according to the resource flow solution; and according to the plurality of cohort-provider-level adjustments, identifying one or more resources in each of the plurality of cohorts that are provided by a first provider to be transferred to a second provider; and automatically sending one or more requests to the first provider and the second provider to transfer the determined one or more first resources from the first provider to the second provider.

According to yet another aspect, a non-transitory computer-readable storage medium for optimizing loan distribution may be configured with instructions executable by one or more processors to cause the one or more processors to perform operations comprising: grouping a plurality of resources into a plurality of cohorts, wherein each of the plurality of resources is associated with a risk level and a benefit level, and resources in each cohort share the same risk level and the same benefit level; obtaining a plurality of provider-level adjustments respectively corresponding to a plurality of providers providing the plurality of resources, wherein each provider-level adjustment represents a value by which a total amount of resources from the corresponding provider is allowed to be changed; constructing an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and provided by the corresponding provider are to be changed according to the resource flow solution; and according to the plurality of cohort-provider-level adjustments, identifying one or more resources in each of the plurality of cohorts that are provided by a first provider to be transferred to a second provider; and automatically sending one or more requests to the first provider and the second provider to transfer the determined one or more first resources from the first provider to the second provider.

According to yet another embodiment, an apparatus for optimizing loan distribution comprises: grouping a plurality of resources into a plurality of cohorts, wherein each of the plurality of resources is associated with a risk level and a benefit level, and resources in each cohort share the same risk level and the same benefit level; obtaining a plurality of provider-level adjustments respectively corresponding to a plurality of providers providing the plurality of resources, wherein each provider-level adjustment represents a value by which a total amount of resources from the corresponding provider is allowed to be changed; constructing an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and provided by the corresponding provider are to be changed according to the resource flow solution; and according to the plurality of cohort-provider-level adjustments, identifying one or more resources in each of the plurality of cohorts that are provided by a first provider to be transferred to a second provider; and automatically sending one or more requests to the first provider and the second provider to transfer the determined one or more first resources from the first provider to the second provider.

Embodiments disclosed in the specification have one or more technical effects. In some embodiments, a task of determining a loan redistribution plan for a large number of lenders may be divided into two subtasks of manageable sizes. At least one of the subtasks may be executed with multiple threads in parallel, which may help to find the optimal loan redistribution plan with a faster speed. In some embodiments, the first subtask may determine a plurality of loan flow decisions with each corresponding to a group of similar loans for a lender (e.g., a total amount X of loans with risk level r and interest level i should be migrated out of lender A), and the second subtask may determine a specific loan distribution strategy based on the loan flow decisions (e.g., loans a, b, c should be migrated from lender A to lender B, and the total amount of loans a, b, c is equal to or close to X). In particular, the first subtask may involve solving an optimization problem with a reasonable number of decision variables, each decision variable representing a loan flow into or out of one cohort of loans, where the loans in each cohort share a same risk level and a same interest level. For example, assuming there are 10 risk levels and 10 interest levels, the optimization problem involving 100 lenders may only have 10,000 decision variables to be determined. In comparison, an optimization problem directly seeking for the specific distribution strategy may have millions of decision variables to be determined (e.g., hundreds of millions of borrowers/loans times hundreds of lenders). The second subtask may involve selecting loans according to the decision variables to determine the specific loan distribution strategy, and recommending the strategy to the platform. While directly determining a loan distribution strategy using optimization theory may be impractical (e.g., due to the facts that the number of decision variables may reach millions, the decision variables may be integers, and some of the constraints may be non-linear), the disclosed hierarchical methods and systems provide a practical solution to determine an approximately optimal loan distribution strategy within a reasonable time. In some embodiments, the disclosed methods and systems may rebalance the loans of the lenders in a loan-servicing platform, so that the risk distribution and interest distribution associated with each lender are the same or similar to the corresponding distributions at the global level (e.g., the risk distribution and interest distribution of all the loans provided by the lenders).

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an example setup for optimizing loan distribution in accordance with various embodiments.

FIG. 2A and FIG. 2B illustrate an example flow for determining a loan flow strategy, in accordance with various embodiments.

FIG. 3A illustrates an example method for determining loan distribution strategy according to a loan flow strategy, in accordance with various embodiments.

FIG. 3B illustrates an exemplary method of determining a loan distribution strategy, in accordance with various embodiments.

FIG. 4 illustrates an exemplary workflow for determining a loan distribution strategy, in accordance with various embodiments.

FIG. 5 illustrates an example method for optimizing loan distribution, in accordance with various embodiments.

FIG. 6 illustrates a block diagram of an example computer system apparatus for optimizing loan distribution, in accordance with various embodiments.

FIG. 7 illustrates an example computing device in which any of the embodiments described herein may be implemented.

### DETAILED DESCRIPTION

The technologies disclosed herein may determine a resource redistribution plan to redistribute resources among a plurality of resource providers, where the resource may be associated with a benefit level and a risk level for the corresponding resource provider. For example, if the resource is cloud storage space for digital data, providing such storage space (e.g., by a cloud storage system) may be associated with a benefit level (e.g., payment to the cloud storage provider for storing such data) and a risk level (e.g., the risk carried by the cloud storage provider, and the associated cost of implementing safeguard measures to prevent the data from leaking) for the resource provider. As another example, if the resource is a loan, providing the loan may be associated with a benefit level (e.g., an interest level) and a risk level (or another type of negative factor) for the lender. Due to various reasons, the distribution of the benefit level and/or the risk level associated with the resources held by one resource provider may be significantly different from that of another resource provider. For example, one resource provider may carry much higher risks than another but enjoy a much lower earning rate. The disclosed technologies in this specification may provide a resource redistribution plan to redistribute the resources among the resource providers in order to rebalance the benefit level and/or the risk level distributions according to a certain criteria.

For the convenience of description, a loan servicing platform is used as an example to describe the embodiments disclosed herein, where the resource to be redistributed may refer to a loan, and the provider may refer to a lender. Each loan served by the lender may be associated with, among other things, a risk level and an interest level. It may be obvious for a person in the art to apply the same ideas to another suitable scenario where resource redistribution is needed.

As described above, after serving the borrowers and lenders for a period of time, the risk and/or interest distributions among the lenders may become unbalanced. There may be various reasons that can cause this type of unbalance. For example, different lenders may have different loan servicing capabilities, interest goals/revenue targets, risk management capabilities. Some lenders may currently bear high risk loans but only receive low interests. The embodiments disclosed herein may determine a loan redistribution strategy to migrate loans among a plurality of lenders in a loan-servicing platform so that the distributions of risk and interest (e.g., associated with the loans) among the lenders are fair and balanced.

In some embodiments, the task to determine the redistribution strategy may be divided into two subtasks, where a first subtask may first determine a loan flow strategy, and a second subtask may then determine a specific loan distribution strategy based on the loan flow strategy. In this specification, “migrate,” “transfer,” and “allocate” are used interchangeably to describe an action of re-distributing loans among lenders; and “optimization model” and “optimization problem” may be used interchangeably.

The purpose of the loan flow strategy may comprise determining, for each lender and each cohort of loans (e.g., the loans in one cohort may share the same risk level and interest level), an amount of loans to be migrated in or out, so that the lenders have balanced risk and interest distributions. It may be appreciated that, regardless how the loans are migrated or rebalanced among the lenders, the global risk distribution and global interest distribution (associated with all the loans provided by all the lenders) may stay the same. As a result, in some embodiments, the goal of the loan flow strategy may be specified to make each lender's individual risk distribution and individual interest distribution the same as or similar to the global risk distribution and the global interest distribution, respectively.

There are two commonly used metrics to measure the balance of risk and interest among lenders, Mean Absolute Percentage Error (MAPE) and Probability Stability Index (PSI). Assuming the risk distribution at the platform-level (e.g., a global level) is determined by function q(x), and an individual lender j's risk distribution is determined by function p(x), where x is one of the predefined risk levels, q and p are distribution functions that may be explicitly define or implied, the MAPE may be determined with the following formula. E ( ) means expected value (or mean).

$$\frac{E ( p ( x ) ) - E ( q ( x ) )}{E ( q ( x ) )}$$

With the same assumption described above, the PSI may be determined as formula (1).

$${\int }_{x} ( p ( x ) - q ( x ) ) ln ( \frac{p ( x )}{q ( x )} ) \qquad ( 1 )$$

where ∫ₓ ( ) is an integral operation, In is a logarithm operation. In the following discussion of this specification, PSI is used as an example to measure the balance between the distributions at individual lender level and the distributions at platform level. It may be appreciated that other metrics (e.g., MAPE) may also be applicable.

There may be other ways to calculate PSI besides using formula (1), such as using a pair of Kullback-Leibler (KL) divergences (e.g.,

$${\int }_{x} ( p ( x ) - q ( x ) ) ln ( \frac{p ( x )}{q ( x )} ) = {D}_{KL} ( p \vert \vert q ) + {D}_{KL} ( q \vert \vert p ) ,$$

where D_{KL} represents KL divergence). This specification does not limit the ways of calculating PSI.

In practice, there may be other factors to be considered when determining the loan flow strategy. For example, a lender may not accept a borrower (as well as the borrower's loans), or a lender may have limits on the amount of loans to be migrated in and/or out. The first subtask may take them into account by creating one or more corresponding constraints as part of the optimization problem, so that the solution to the optimization problem may respect these constraints.

Once the loan flow strategy is determined, the second subtask may be created to determine a specific loan distribution strategy. In some embodiments, the second subtask may seek for an exact solution by solving an optimization problem (different from the optimization problem in the first subtask). However, such an optimization problem may not have an exact solution for various reasons (e.g., the decision variables have binary values). Therefore, in some embodiments, greedy algorithms may be used to seek an approximation to the exact solution. It may be especially efficient when the platform serves a large number of small size loans.

By separating the loan flow strategy determination (e.g., determining the amount of loans to be transferred by each lender) and loan migration strategy determination (e.g., selecting specific loans to transfer), another noticeable advantage is that the loan migration strategy determination may be executed using parallel processing mechanisms. As a result, the overall time required to determine a valid loan migration plan by the embodiments disclosed in this specification is reduced compared to traditional methods such as directly searching for the loan plan.

In this specification, it is assumed that one loan corresponds to one borrower, and there is a one-to-one mapping between the loan and the borrower. This assumption may be reasonably expanded as one borrower may borrower multiple loans, and each loan may be associated with multiple borrowers. However, these expanded cases may be easily transformed so that the previous assumption still applies. For example, when a borrower is associated with multiple loans, it is possible to treat the borrower behind each of the loans as an individual (even though the individuals refer to the same person). As a result, in this specification, migrating a “loan” may mean migrating a “borrower” of the loan.

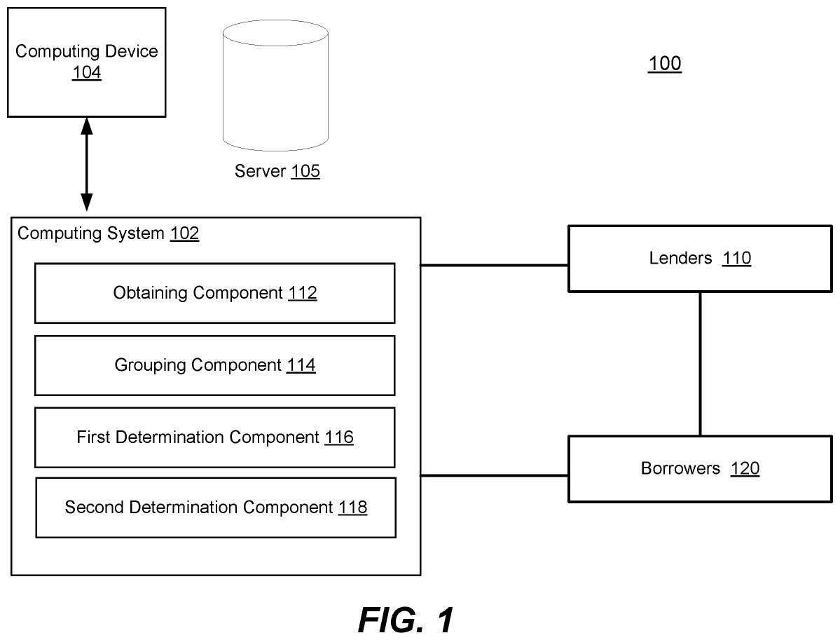

FIG. 1 illustrates an example system for optimizing loan distribution, in accordance with various embodiments. The components of the system 100 are intended to be illustrative. Depending on the implementation, the system 100 may include additional, fewer, or alternative components. It is to be understood that although one computing device is shown in FIG. 1, any number of computing devices may be included in the system 100. The computing system 102 may be implemented in one or more networks (e.g., enterprise networks), one or more endpoints, one or more servers (e.g., server 105), or one or more clouds. The server 105 may include hardware or software which manages access to a centralized resource or service in a network. A cloud may include a cluster of servers and other devices which are distributed across a network.

In some embodiments, the system 100 may include a computing system 102, a computing device 104, a server 105, and the computing system 102 may communicate with loan borrowers 120 and loan lenders110 through corresponding computing devices. The computing system 102 may be understood as a platform comprising both online servicing interfaces and an offline (e.g., backend) computing system. The computing device 104 may be associated with the computing system 102 by providing computing capacity. The server 105 may be associated with the computing system 102 by providing storage and/or computing capacity. In some embodiments, the computing device 104 may be implemented on or as various devices such as a mobile phone, tablet, server, desktop computer, laptop computer, etc. The computing system 102 may communicate with the computing device 104, and other computing devices. Communication between devices may occur over the internet, through a local network (e.g., LAN), through direct communication (e.g., BLUETOOTH™, radio frequency, infrared), etc.

In some embodiments, the computing system 102 may include an obtaining component 112, a grouping component 114, a first determination component 116, and a second determination component 118. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other components of the system 100.

In some embodiments, the obtaining component 112 in the computing system 102 may be configured to collect various data. The data may include current loan distribution (e.g., lender j's current loans, whether loan i is currently assigned to lender j), whether loan i is allowed to be assigned to lender j, the amount of loan i, the predefined risk levels (e.g., 10 levels), the predefined interest levels (e.g., 10 levels), each loan's risk level and interest level, lender j's loan distribution target (e.g., a positive number representing an amount of loans expected to migrate in, a negative number representing an amount of loans expected to migrate out, or zero representing no change). In some embodiments, the lender j's loan distribution target may be further divided: the migrate-in limit and the migrate-out limit for the lender j's loans with risk level m and interest level n. Based on the obtained data, some intermediate variables may be determined. For example, the percentages of the loans with a specific risk level at individual lender's level and the global level (e.g., at platform level) may be determined. As another example, the percentages of the loans with a specific interest level at individual lender's level and the global level (e.g., at platform level) may also be determined.

In some embodiments, the grouping component 114 in the computing system 102 may be configured to group the loans based on corresponding risk levels and/or interest levels. The grouping may occur at the platform level as well as individual lender level. The grouping process may comprise multiple phases, and may be performed in parallel. Since the number of loans being served by a loan-serving platform may easily be in the hundreds of millions, the grouping task may be impractical to be performed by human or manual methods.

For example, the loans being tracked by the platform (e.g., served by the lenders) may be grouped based on risk levels. Assuming there are 10 risk levels, the loans may be grouped into 10 groups, each group including loans with the same risk level. Similarly, the loans may be grouped based on interest levels. Assuming there are 10 interest levels, the loans may be grouped into 10 groups, each group including loans with the same interest level. Then the grouping component 114 may divide the loans into a plurality of cohorts, with each cohort corresponding to one risk level and one interest level (e.g., the loans within a cohort share the same risk level and the same interest level). Assuming there are 10 risk levels and 10 interest levels, the number of the cohorts may be 100. The loans associated with each individual lender may also be grouped in similar ways.

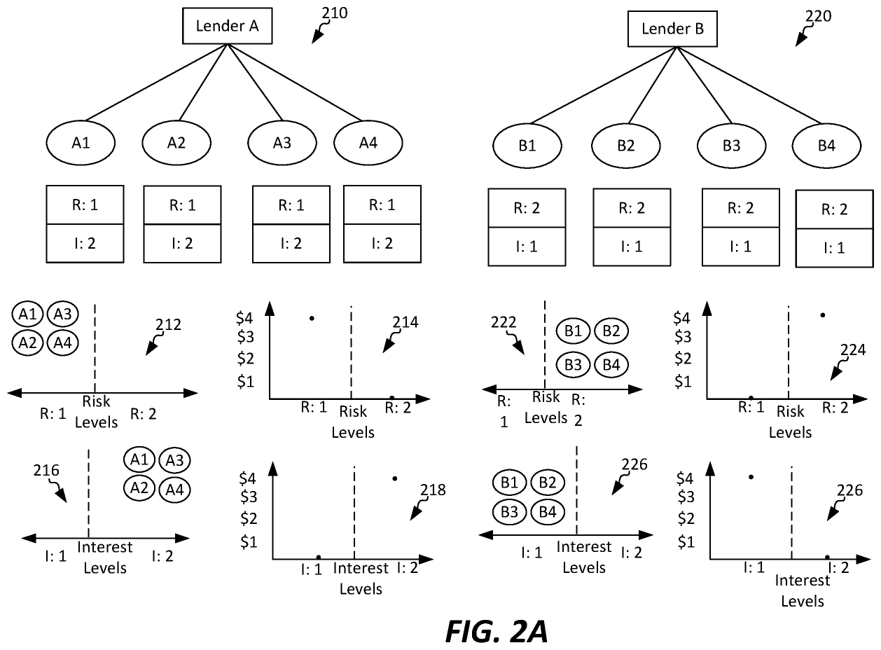

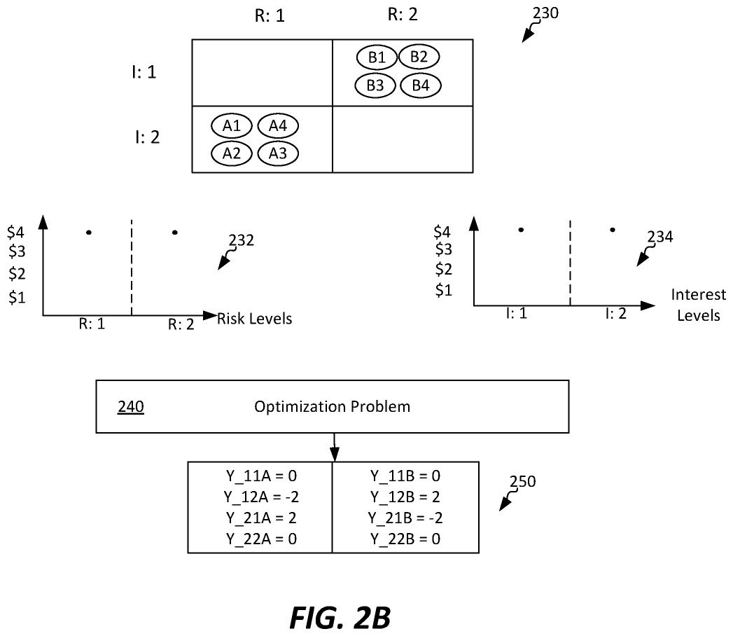

In some embodiments, the first determination component 116 may be configured to construct an optimization problem based on the data obtained by the obtaining component 112 and grouping results from the grouping component 114. The optimization problem may include a plurality of decision variables, with each decision variable representing a loan flow amount corresponding to one lender's loans within one of the cohorts. For example, assuming there are 10 risk levels, 10 interest levels, and 100 lenders, the optimization problem may have 10*10*100 decision variables, each decision variable yₘₙⱼ representing a loan flow amount (e.g., the amount of loans to be migrated in or out) corresponding to lender j's loans with risk level m and interest level n. The value of the decision variable may be positive (e.g., meaning some loans are to be migrated to lender j), negative (e.g., meaning some loans are to be migrated out of lender j), or zero (e.g., no change). The optimization problem may include a plurality of constraints so that the solution to the optimization problem may comply with the practical requirements (such as distribution limits, whether a lender will accept a borrower/loan). The solution to this optimization problem may determine the values for the decision variables, representing a loan flow strategy. An exemplary flow is illustrated in FIGS. 2A and 2B.

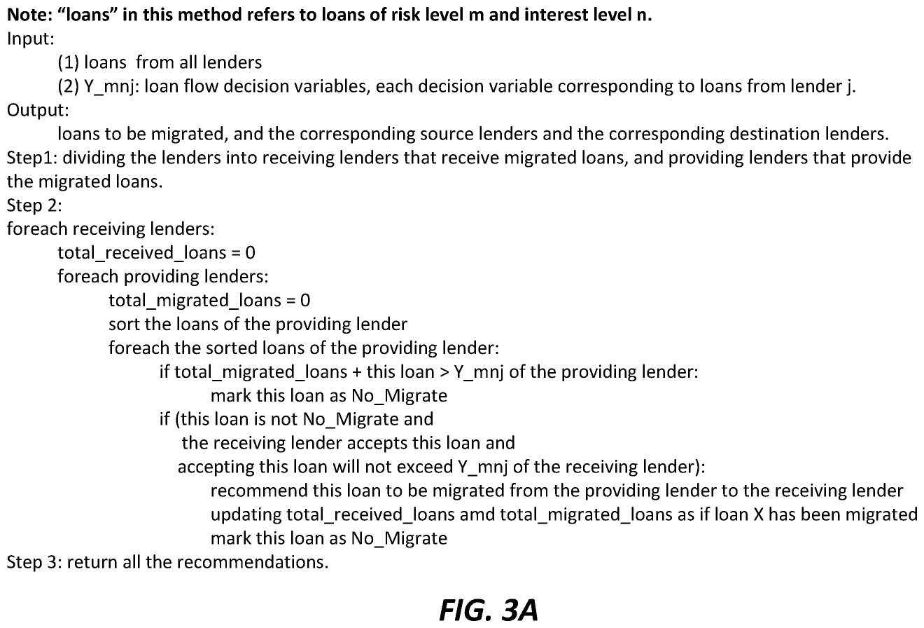

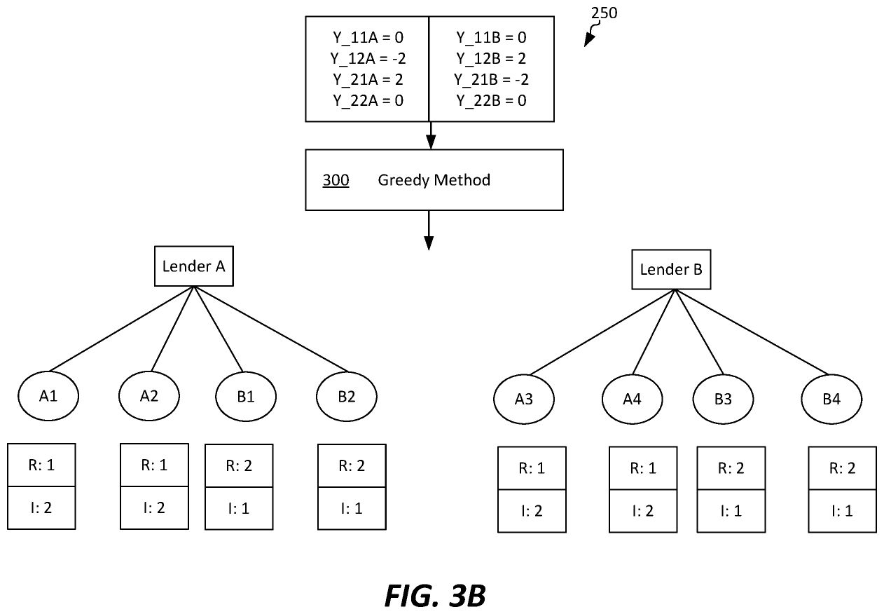

In some embodiments, the second determination component 118 may be configured to determine a loan distribution strategy based on the loan flow strategy generated by the first determination component 116. Compared to the loan flow strategy that determines the amount of individual lender's loans within a cohort to be migrated in or out, the loan distribution strategy may determine which individual loans to be migrated from one lender to another lender, according to the loan flow strategy. In some embodiments, greedy algorithm-based solutions may be adopted to seek for an approximated solution. For example, the solution may indicate a few loans with risk level m and interest level n from lender j should be migrated to lender k, the total amount of the few loans may be close to (e.g., may not be exactly the same as) the value of the corresponding loan flow decision variable. An exemplary algorithm is illustrated in FIG. 3.

FIG. 2A and FIG. 2B illustrate an example flow for determining a loan flow strategy, in accordance with various embodiments. Before explaining the specific example illustrated in FIGS. 2A, 2B, an exemplary optimization problem constructed by the first determination component 116 is described first. The exemplary optimization problem may be constructed as below formulas:

$$\begin{matrix}min {\sum }_{j} {( \frac{{d}_{j}}{{T}_{j}} - 1 )}^{2} & ( 2 ) \\ s . t . {\sum }_{j} {y}_{mnj} = 0 \text{∀} m , n & ( 3 ) \\ {\sum }_{m} ( {p}_{jm} - {q}_{m} ) ln \frac{{p}_{jm}}{{q}_{m}} < ɛ \text{∀} j & ( 4 ) \\ {\sum }_{n} ( {p}_{jn} - {q}_{n} ) ln \frac{{p}_{jn}}{{q}_{n}} < ɛ \text{∀} j & ( 5 ) \\ {l}_{mnj} \leq {y}_{mnj} \leq {u}_{mnj} \text{∀} m , n , j & ( 6 )\end{matrix}$$

where s. t. stands for “subject to,” ∀ stands for “for any given,” yₘₙⱼ is the decision variable of the optimization problem, representing the amount of lender j's loans with risk level m and interest level n to be migrated in or out, which may be positive or negative;

lₘₙⱼ corresponds to the floor value of loan flow limit of lender j, e.g., a negative value;

uₘₙⱼ corresponds to the ceiling value of loan flow limit of lender j, e.g., a positive value;

dⱼ=ΣₘΣₙyₙₘⱼ corresponds to the amount of loans to be migrated in or out of lender j according to the given loan flow strategy;

Tⱼ corresponds to a predetermined amount of loan allowed to be migrated into or out of lender j (e.g., positive, negative, or zero) , which may be determined by each individual lender, the platform, or both through negotiation;

ε corresponds to a predetermined threshold, e.g., a small number;

$${p}_{jm} = \frac{{\sum }_{n} {z}_{nmj}}{{f}_{j}}$$

corresponds to the percentage of lender j's loans that have risk level m (out of lender j's loans) after the loans are migrated according to the given loan flow strategy, where fⱼ=ΣₘΣₙzₙₘⱼ corresponds to the new amount of lender j's loans after the loans are migrated according to the given loan flow strategy, where zₘₙⱼ=yₙₘⱼ₀+yₙₘⱼ corresponds to the new amount of lender j's loans that have risk level m and interest level n after the loans are migrated according to the given loan flow strategy, where yₘₙⱼ₀ corresponds to the current amount of lender j's loans that have risk level m and interest level n;

$${p}_{jn} = \frac{{\sum }_{m} {z}_{nmj}}{{f}_{j}}$$

corresponds to, after the loans are migrated according to the given loan flow strategy, the percentage of lender j's loans that have interest level n (out of lender j's loans);

$${q}_{m} = \frac{{\sum }_{j} {\sum }_{n} {z}_{nmj}}{{\sum }_{j} {f}_{j}}$$

corresponds to the percentage of the platform's (at global level) loans that have risk level m (out of all the loans being tracked by the platform); and

$${q}_{n} = \frac{{\sum }_{j} {\sum }_{m} {z}_{nmj}}{{\sum }_{j} {f}_{j}}$$

corresponds to the percentage of the platform's (at global level) loans that have interest level n (out of all the loans being tracked by the platform).

The formula (2) is the objective function of the optimization problem, which indicates the optimal solution (e.g., the loan flow strategy) may minimize the difference between, for each of the plurality of lenders, the corresponding lender-level adjustment and a sum of one or more of the plurality of cohort-lender-level adjustments corresponding to each lender. That is, the objective function is to minimize the difference between the amount of the loans to be migrated (e.g., the sum of one or more of the plurality of cohort-lender-level adjustments corresponding to the lender) and the amount of loans allowed to be migrated (e.g., the lender-level adjustment). In the cases where Tⱼ=0, the objective function in formula (2) may simply ignore the corresponding lenders (as these lenders do not allow distribution).

The formula (3) is a constraint of the optimization problem, which indicates no matter how the loans are migrated among the lenders, the total amount of loans of risk level m and interest level n will not change;

The formula (4) is another constraint of the optimization problem, which uses the PSI calculation illustrated in formula (1). This constraint indicates the determined loan flow strategy may balance the loans among the lenders so that the percentage of each individual lender's loans of risk level m (out of the individual lender's loans) is similar to the percentage of the platform's loans of risk level m (out of platform's loans).

Similarly, the formula (5) also uses the PSI calculation illustrates in formula (1), and indicates the determined loan flow strategy may balance the loans among the lenders so that the percentage of each individual lender's loans of interest level n (out of the individual lender's loans) is similar to the percentage of the platform's loans of interest level n (out of platform's loans). It may be appreciated that even though formula (4) and formula (5) share the same threshold ε in the above exemplary optimization problem, it is possible that these two constraints use different thresholds.

The formula (6) is yet another constraint of the optimization problem, indicating the determined loan flow strategy may not violate the loan flow limits associated with each lender.

Referring to FIG. 2A, the example involves two lenders: lender A 210, and lender B 220. Lender A provides four loans A1, A2, A3, and A4, and lender B provides four loans B1, B2, B3, and B4. As shown in FIG. 2A, loans A1-A4 and B1-B4 are each associated with a risk level (denoted as “R” in FIG. 2A) and an interest level (denoted as “I” in FIG. 2A). For the sake of simplicity, the example in FIG. 2A assumes that the loans have the same size, with each loan is $1, and there are two risk levels (1, 2) and two interest levels (1, 2). For example, loan A1 has risk level 1 and interest level 2, and loan B3 has risk level 2 and interest level 1.

Accordingly, lender A's loans may be grouped according to risk levels 212, and the corresponding distribution 214 may show that lender A's loans are all at risk level 1. Similarly, lender A's loans may also be grouped according to interest levels 216, and the corresponding distribution 218 may show that lender A's loans are all with interest level 2. Assuming risk level 1 means low risk and interest level 2 means high interest, it means lender A is a good position because it only has low risk and high interest loans.

Similarly, lender B's loans may be grouped according to risk levels 222, and the corresponding distribution 224 may show that lender B's loans are all at risk level 2. Similarly, lender B's loans may also be grouped according to interest levels 226, and the corresponding distribution 228 may show that lender B's loans are all with interest level 1. In comparison to lender A, lender B is at a much worse position as it only has high risk but low interest loans.

Referring to FIG. 2B, the platform's loan (at global level) may be grouped into a plurality of cohorts, each cohort corresponding to a specific risk level and interest level. In this example, since there are two risk levels and two interest levels, the number of cohorts may be 2*2=4. As shown in FIG. 2B, the four cohorts 230 may comprise cohort (R:1, I:1) with loans of risk level 1 and interest level 1, cohort (R:1, I:2) with loans of risk level 1 and interest level 2, cohort (R:2, I:1) with loans of risk level 2 and interest level 1, and cohort (R:2, I:2) with loans of risk level 2 and interest level 2. In this particular example, lender A's loans are in cohort (R:1, I:2), lender B's loans are in cohort (R:2, I:1). Accordingly, the risk-related distribution of the loans in the platform may be represented by 232, where the number of loans with risk level 1 is the same as the number of loans with risk level 2 (e.g., both are $4). Similarly, the interest-related distribution of the loans in the platform may be represented by 234, where the number of loans with interest level 1 is the same as the number of loans with interest level 2 (e.g., both are 4).

The constructed optimization problem 240 may take above values and other necessary variables/constraints into account. The decision variables of the optimization problem may not have to be integers (as they represent an amount of loans). Furthermore, since the number of decision variables is determined by the number of risk levels, the number of interest levels, and the number of lenders (e.g., 2*2*2=8 in the example shown in FIGS. 2A and 2B), the size of the optimization problem may likely be manageable. Based on empirical results, one general CPU may be used to solve the optimization problem with 10*10*100 decision variables within a few minutes.

The solution to such optimization problem 240 may determine the values of the decision variables. For the example in FIG. 2B, one possible loan flow strategy (represented by the decision variables) may be illustrated as 250 in FIG. 2B. Each decision variable may correspond to one lender's loans at one risk level and one interest level, such as y_{11A}=0 means lender A's loans with risk level 1 and interest level 1 is not being migrated, and y_{12A}=−2 means $2 of lender A's loans with risk level 1 and interest level 2 is being migrated out of lender A. That is, a negative value indicates a “migrating out” action, and correspondingly, a positive value indicates a “migrating in” action. As shown in FIG. 2B, the loan flow strategy determined by the optimization problem 240 is represented by 8 decision variables 250. Those skilled in the art may appreciate that the above description is exemplary, and depending on the implementation, it is possible to use negative values to indicate “migrating in” actions and use positive values to indicate “migrating out” actions.

FIG. 3A illustrates an example method for determining loan distribution strategy according to a loan flow strategy, in accordance with various embodiments. A loan flow strategy may provide guidance such as an amount of loans of a specific risk level and a specific interest level should be migrated in or out of an individual lender. Based on the loan flow strategy, the loan distribution strategy may be developed to specify, which loans (i.e., the loans with the specific risk level and the specific interest level) should be migrated from a source (e.g., a first lender) to a destination (e.g., a second lender). In some embodiments, instead of looking for an exact solution to satisfy the loan flow strategy, a greedy algorithm-based approach may be adopted to approximate the optimal solution.

An example method is shown in FIG. 3A, where the input of the method may include loans of risk level m and interest level n from all lenders, and part of the loan flow strategy corresponding to the loans of risk level m and interest level n. The output of the method may include loans to be migrated, and the corresponding source lenders and the corresponding destination lenders.

The method may start with step 1 by, for loans in a same cohort (e.g., loans sharing the same risk level and the same interest level), dividing all the lenders into receiving lenders that receive migrated loans, and providing lenders that provide the loans to be migrated. This step may be based on the values of the loan flow decision variables. For example, a negative value of yₘₙⱼ may represent some loans (e.g., with risk level m and interest level n) may be migrated out of the current lender j, and thus lender j is a providing lender regarding the loans with risk level m and interest level n. It may be noted that a lender may be a providing lender for loans with one risk/interest combo and a receiving lender for loans with a different risk/interest level combo at the same time.

The method may then proceed to step 2 to examine each combination of a receiving lender and a providing lender. For a pair of a receiving lender and a providing lender, the method may start with sorting the loans (of risk level m and interest level n) from the providing lender. This sorting may be implemented in various ways. For example, the sorting may be based on the sizes of the loans and either in an ascending (or descending) order, and the method then starts the examination from the loan with the smallest size (or the largest size if the loans are sorted in a descending order). As another example, the sorting may place the loans of middle size at the beginning, so that the method starts the examination from the middle size loans first. As another example, the sorting may be based on one or more suitable priorities other than the loan size.

When examining loan X from the providing lender, the method may first check if the amount of loans migrated so far (e.g., total_migrated_loans variable in FIG. 3A) plus the loan X's size exceeds the determined loan flow limit determined by the yₘₙⱼ of the providing lender. If so, it means loan X should not be migrated. Otherwise, the method may further check if the receiving lender will accept loan X, and whether accepting loan X will exceed the receiving lender's allowance (e.g., the yₘₙⱼ of the receiving lender). If both are true, it means loan X may be migrated from the providing lender to the receiving lender. Accordingly, the yₘₙⱼ of the providing lender and the yₘₙⱼ of the receiving lender may be adjusted as if the loan X has been migrated from the providing lender to the receiving lender. Afterwards, the method may mark loan X as No_Migrate (e.g., a flag) so that this loan will not be migrated twice.

After iterating all the combinations of the receiving lenders and the providing lenders, the method may return all the recommended distributions. The platform may subsequently make corresponding requests to the receiving lenders and providing lenders to suggest loan distributions.

Each run of the example method in FIG. 3A may return a plurality of loan distribution recommendations (e.g., loan B1 should be migrated from lender B to lender A) for the loans in the same cohort sharing the same risk level and the same interest level. Since there is no dependency among the plurality of cohorts, the method in FIG. 3A may be executed in parallel with each instance corresponding to one cohort. By allowing parallel processing, the overall time to find an optimal or an approximately optimal loan migration plan may be significantly reduced, especially when the number of lenders is enormous. For example, a plurality of parallelly executable processing threads respectively corresponding to the plurality of cohorts may be created and executed in parallel with one or more processing units. In each of the threads, a loan distribution strategy may be determined for the lenders indicating how the loans in the corresponding cohort should be rebalanced among the lenders. The processing units may refer to cores or threads of one or more processors, e.g., GPUs. In some embodiments, the processing units may be GPUs, and since each computation occurred in the GPUs (e.g., in each thread) may not support complex logics (due to the memory layout in each GPU), one or more CPUs may be introduced to perform serial instruction processing (e.g., more complicated computations) and flow controls (e.g., checking whether exit condition is satisfied).

In some embodiments, alternative methods may be used for determining the loan distribution strategy according to the loan flow strategy. For example, according to the cohort-lender-level adjustments provided by the loan flow strategy, within each cohort, the lenders may first be divided into two groups: receiving groups and providing groups, where the lenders in the receiving groups will receive loans migrated from the providing lenders. Each of the providing lenders may then determine which loans it owns can be migrated out, denoted as to-be-migrated loans. These to-be-migrated loans from all providing lenders may subsequently be aggregated to a pool for the receiving lenders to pick. Among these steps, parallel processing may be adopted to determine each providing lender's to-be-migrated loans.

FIG. 3B illustrates an exemplary method of determining a loan distribution strategy, in accordance with various embodiments. The greedy method 300 in FIG. 3B may take the loan flow decision variables 250 as input (FIG. 2B illustrates the process to obtain the loan flow decision variables 250). During the execution of the greedy method 300, for loans of risk level 1 and interest level 2, lender A may be the providing lender (as Y_12A=−2 is a negative value) and lender B may be the receiving lender (as Y_12B=2 is a positive value). The greedy method 300 may determine a total $2 of loans of risk level 1 and interest level 2 may be migrated from lender A to lender B. For example, loan A3 and loan A4 may be migrated to lender B. Similarly, for loans of risk level 2 and interest level 1, lender A may be treated as the receiving lender (as Y_21A=2 is a positive value) while lender B may be the providing lender (as Y_21B=2 is a negative value). The greedy method 300 may determine a total $2 of loans of risk level 2 and interest level 1 may be migrated from lender B to lender A. For example, loan B1 and loan B2 may be migrated to lender A. As a result, after the distribution, lender A may host loans A1, A2, B1, and B2, lender B may host loans A3, A4, B3, and B4. Thus, lender A has 50% of loans of risk level 1, and 50% of loans of risk level 2, which mirrors the risk-related distribution at platform level (as shown in FIG. 2B chart 232 where 50% of loans have risk level 1, and 50% of loans have risk level 2). Similarly, lender B has 50% of loans of interest level 1, and 50% of loans of interest level 2, which is the same as interest-related distribution at platform level (as shown in FIG. 2B chart 234).

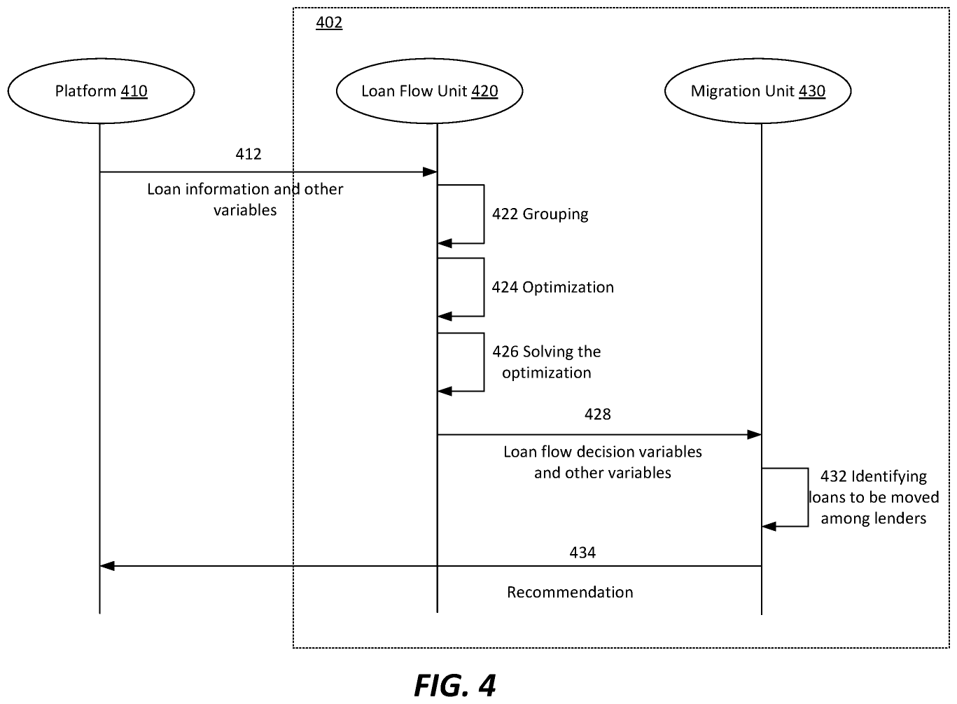

FIG. 4 illustrates an exemplary workflow for determining a loan distribution strategy, in accordance with various embodiments. As shown in FIG. 4, the workflow may include multiple components, such as a loan-servicing platform 410, a loan flow unit 420, and a distribution unit 430. In some embodiments, the loan-servicing platform 410 may be understood as a client-facing (borrowers and lenders) platform, or a server that supports a client-facing platform. The loan flow unit 420 and migration unit 430 may be implemented as services in a backend system 402. The loan-servicing platform 410 may have access to the information of the loans being monitored by the platform (e.g., the loans serviced by the platform).

In some embodiments, the platform 410 may send loan information and other variables or constraints to the loan flow unit 420 to determine a loan flow strategy. The loan flow unit 420 may perform various operations such as grouping the loans at step 422 (based on risk levels, interest levels, and both), constructing an optimization problem at step 424 (details are described in FIG. 2A), and solving the optimization problem at step 426 using various solvers (e.g., open source tools or programs solving optimization problems). Subsequently, the loan flow unit 420 may deliver the determined decision variables (representing the loan flow strategy) to the distribution unit 430 at step 428. The distribution unit 430 may then determine a specific loan distribution strategy, e.g., by identifying loans to be migrated from one lender to another lender, at step 432. The distribution unit 430 may then recommend the loan distribution strategy to the platform 410 at step 434. The platform may then make requests to the involved lenders to migrate loans according to the recommended loan distribution strategy.

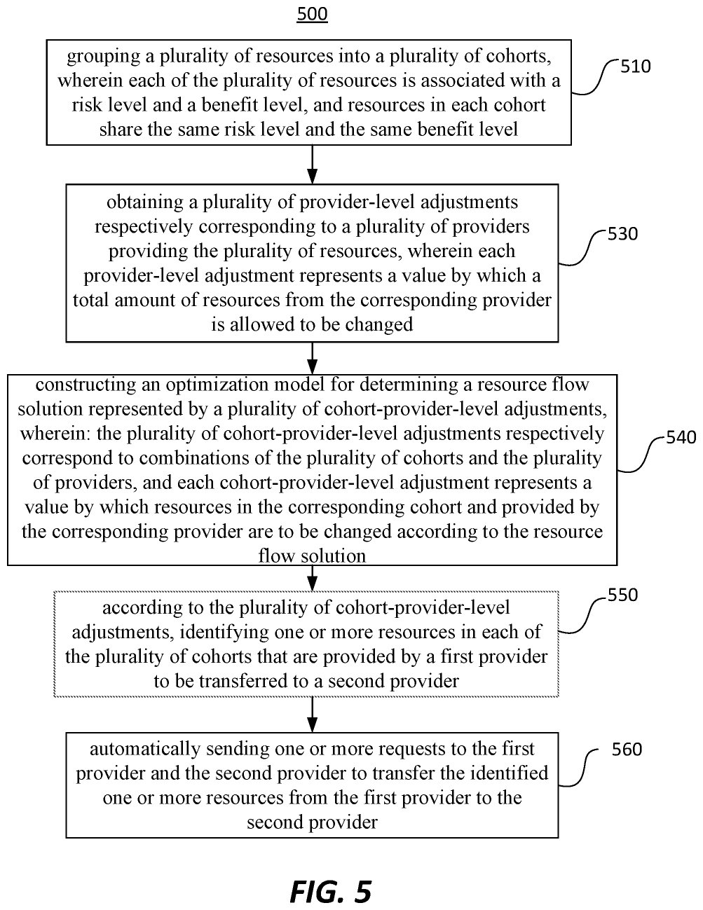

FIG. 5 illustrates an example method for optimizing loan distribution, in accordance with various embodiments. The method 500 may be performed by a device, apparatus, or system for personalizing offers for users. The method 500 may be performed by one or more components of the setup illustrated by FIG. 1, such as the computing system 102, and the computing device 220. Depending on the implementation, the method 500 may include additional, fewer, or alternative steps performed in various orders or in parallel.

Block 510 includes grouping a plurality of resources into a plurality of cohorts, wherein each of the plurality of resources is associated with a risk level and a benefit level, and resources in each cohort share the same risk level and the same benefit level. In some embodiments, the grouping a plurality of resources into a plurality of cohorts comprises: grouping the plurality of resources, based on each resource's risk level, into one or more first groups, wherein each of the first groups is associated with a risk level from a set of predetermined risk levels; grouping the plurality of resources, based on each resource's benefit level, into one or more second groups, wherein each of the second groups is associated with a benefit level from a set of predetermined benefit levels; generating the plurality of cohorts respectively corresponding to combinations of the set of predetermined risk levels and the set of predetermined benefit level; and identifying zero or more resources from the plurality of resources to be grouped in each of the plurality of cohorts based on an intersection of the first group associated with the corresponding risk level and the second group associated with the corresponding benefit level.

Block 530 includes obtaining a plurality of provider-level adjustments respectively corresponding to a plurality of providers providing the plurality of resources, wherein each provider-level adjustment represents a value by which a total amount of resources from the corresponding provider is allowed to be changed.

Block 540 includes constructing an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and provided by the corresponding provider are to be changed according to the resource flow solution.

Block 550 includes identifying one or more resources in each of the plurality of cohorts that are provided by a first provider to be transferred to a second provider according to the plurality of cohort-provider-level adjustments. In some embodiments, the identifying one or more resources in each of the plurality of cohorts that are provided by a first provider to be transferred to a second provider according to the plurality of cohort-provider-level adjustments comprises: identifying one or more first resources in a first cohort and provided by a first provider, wherein a total value of the one or more first resources is not greater than a first value associated with a first cohort-provider-level adjustment corresponding to the first cohort and the first provider; and identifying a second provider, wherein a total amount of the one or more first resources is not greater than a second value associated with a second cohort-provider-level adjustment corresponding to the first cohort and the second provider. In some embodiments, the identifying one or more first resources in a first cohort and provided by a first provider comprises: sorting resources in the first cohort and provided by the first provider; sequentially selecting a maximum number of the sorted resources with a total resource amount not greater than a first value associated with a first cohort-provider-level adjustment corresponding to the first cohort and the first provider; and determining the selected resources as the one or more first resources. In some embodiments, the first cohort-provider-level adjustment comprises a negative value, indicating an amount of resources to be transferred out of the first provider; and the first value is an absolute value of the negative value. In some embodiments, the second cohort-provider-level adjustment comprises a positive value, representing an amount of resources to be transferred to the second provider; and the second value is equal to the positive value.

In some embodiments, the identifying one or more resources in each of the plurality of cohorts that are provided by a first provider to be transferred to a second provider according to the plurality of cohort-provider-level adjustments comprises: creating a plurality of parallelly executable processing threads respectively corresponding to the plurality of cohorts, wherein each of the parallelly executable processing threads executes instructions to determine a resource distribution strategy to redistribute the resources among providers of resources in the corresponding cohort; and parallelly executing the plurality of parallelly executable processing threads. In some embodiments, for each of the plurality of cohorts, the corresponding processing thread performs iterative operations comprising: dividing the plurality of providers into one or more providing providers and one or more receiving providers according to the plurality of cohort-provider-level adjustments; and for each of the receiving providers, iterating the providing providers to collect one or more resources in the cohort to transfer from the providing providers to the receiving provider based on cohort-provider-level adjustments associated with the providing providers and the receiving provider.

Block 560 includes automatically sending one or more requests to the first lender and the second lender to transfer the determined one or more first loans from the first lender to the second lender.

In some embodiments, the method 500 may further comprise obtaining a global risk distribution and a global benefit distribution, wherein the global risk distribution corresponds to a distribution of the plurality of resources at different risk level, and the global benefit distribution corresponds to a distribution of the plurality of resources at different benefit level, and the optimization model comprises: an objective function that minimizes a difference between, for each of the plurality of providers, the corresponding provider-level adjustment and a sum of one or more of the plurality of cohort-provider-level adjustments corresponding to the provider; a first constraint requiring, for a given resource flow solution, a difference between a risk distribution of each provider and the global risk distribution is below a first threshold; and a second constraint requiring, for a given resource flow solution, a difference between a benefit distribution of each provider and the global benefit distribution is below a second threshold. In some embodiments, the difference between the risk distribution of each provider and the global risk distribution is determined as a Probability Stability Index (PSI), calculated as

$${\sum }_{m} ( {p}_{jm} - {q}_{m} ) ln \frac{{p}_{jm}}{{q}_{m}} ,$$

where: m corresponds to a risk level; j corresponds to an identifier corresponding to a provider; pⱼₘ corresponds to a ratio of an amount of jₜₕ provider's resources at risk level m to an amount of the jₜₕ provider's total resources; qₘ corresponds to a ratio of an amount of the plurality of providers' resources at risk level m to an amount of the plurality of resources; and In refers to a natural logarithm. In some embodiments, the first threshold and the second threshold are identical. In some embodiments, the optimization model further comprises a third constraint that requires each of the plurality of cohort-provider-level adjustments is within a range, and a fourth constraint that requires a total sum of the plurality of cohort-provider-level adjustments is zero.

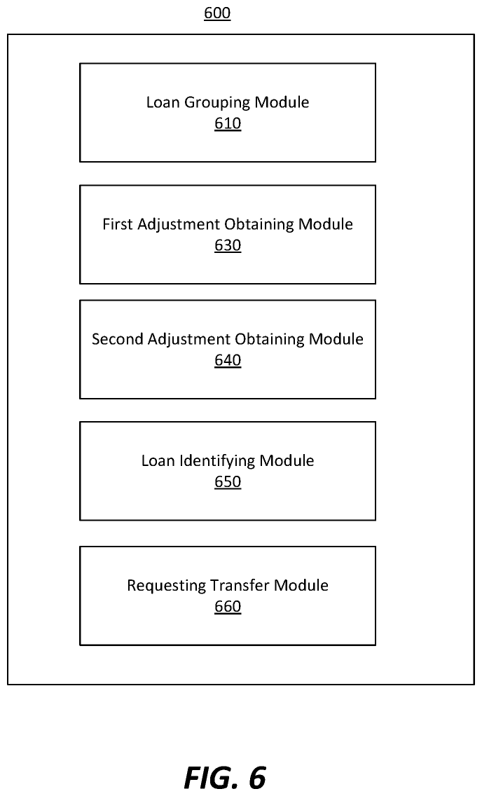

FIG. 6 illustrates a block diagram of a computer system apparatus for optimizing allocation of borrowing requests in accordance with some embodiments. The components of the computer system 600 presented below are intended to be illustrative. Depending on the implementation, the computer system 600 may include additional, fewer, or alternative components.

The computer system 600 may be an example of an implementation of one or more components of the computing system 102. The flows and methods illustrated in FIGS. 1-5 may be implemented by the computer system 600. The computer system 600 may comprise one or more processors and one or more non-transitory computer-readable storage media (e.g., one or more memories) coupled to the one or more processors and configured with instructions executable by the one or more processors to cause the system or device (e.g., the processor) to perform the above-described method, e.g., the method 500. The computer system 600 may comprise various units/modules corresponding to the instructions (e.g., software instructions).

In some embodiments, the computer system 600 may be referred to as an apparatus for optimizing allocation of borrowing requests. The apparatus may comprise a loan grouping module 610, a first adjustment obtaining module 630, a second adjustment obtaining module 640, a loan identifying module 650, and a requesting transfer module 660. In some embodiments, the loan grouping module 610 may group a plurality of resources into a plurality of cohorts, wherein each of the plurality of resources is associated with a risk level and a benefit level, and resources in each cohort share the same risk level and the same benefit level; the first adjustment obtaining module 630 may a plurality of provider-level adjustments respectively corresponding to a plurality of providers lending the plurality of resources, wherein each provider-level adjustment represents a value by which a total amount of resources from each provider is allowed to be changed; the second adjustment obtaining module 640 may construct an optimization model for determining a resource flow solution represented by a plurality of cohort-provider-level adjustments, wherein: the plurality of cohort-provider-level adjustments respectively correspond to combinations of the plurality of cohorts and the plurality of providers, and each cohort-provider-level adjustment represents a value by which resources in the corresponding cohort and lent by the corresponding provider are to be changed according to the resource flow solution; the loan identifying module 650 may one or more resources in each of the plurality of cohorts that are lent by a first provider to be transferred to a second provider according to the plurality of cohort-provider-level adjustments; and the requesting transfer module 660 may automatically send one or more requests to the first provider and the second provider to transfer the determined one or more first resources from the first provider to the second provider.

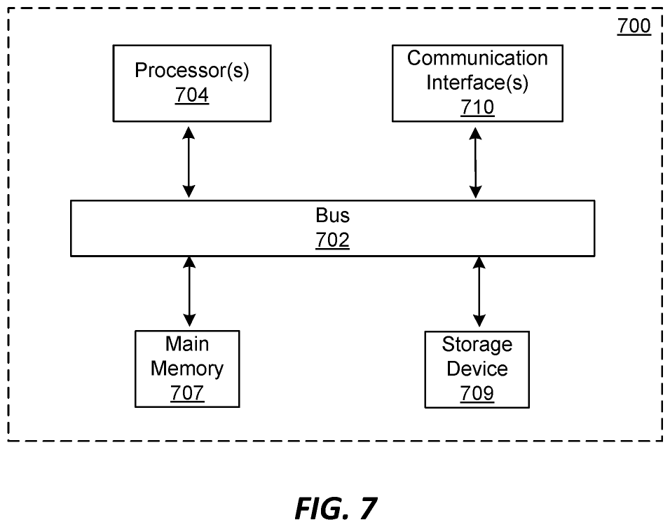

FIG. 7 illustrates an example computing device in which any of the embodiments described herein may be implemented. The computing device may be used to implement one or more components of the systems and the methods shown in FIGS. 1-6 The computing device 700 may comprise a bus 702 or other communication mechanism for communicating information and one or more hardware processors 704 coupled with bus 702 for processing information. Hardware processor(s) 704 may be, for example, one or more general purpose microprocessors.

The computing device 700 may also include a main memory 707, such as a random-access memory (RAM), cache and/or other dynamic storage devices, coupled to bus 702 for storing information and instructions to be executed by processor(s) 704. Main memory 707 also may be used for storing temporary variables or other intermediate information during execution of instructions to be executed by processor(s) 704. Such instructions, when stored in storage media accessible to processor(s) 704, may render computing device 700 into a special-purpose machine that is customized to perform the operations specified in the instructions. Main memory 707 may include non-volatile media and/or volatile media. Non-volatile media may include, for example, optical or magnetic disks. Volatile media may include dynamic memory. Common forms of media may include, for example, a RAM, a DRAM, a PROM, and EPROM, a FLASH-EPROM, NVRAM, any other memory chip or cartridge, or networked versions of the same.

The computing device 700 may implement the techniques described herein using customized hard-wired logic, one or more ASICs or FPGAs, firmware and/or program logic which in combination with the computing device may cause or program computing device 700 to be a special-purpose machine. According to one embodiment, the techniques herein are performed by computing device 700 in response to processor(s) 704 executing one or more sequences of one or more instructions contained in main memory 707. Such instructions may be read into main memory 707 from another storage medium, such as storage device 709. Execution of the sequences of instructions contained in main memory 707 may cause processor(s) 704 to perform the process steps described herein. For example, the processes/methods disclosed herein may be implemented by computer program instructions stored in main memory 707. When these instructions are executed by processor(s) 704, they may perform the steps as shown in corresponding figures and described above. In alternative embodiments, hard-wired circuitry may be used in place of or in combination with software instructions.

The computing device 700 also includes a communication interface 710 coupled to bus 702. Communication interface 710 may provide a two-way data communication coupling to one or more network links that are connected to one or more networks. As another example, communication interface 710 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for optimizing resource distribution, comprising:
grouping a plurality of resources into a plurality of cohorts, wherein each of the plurality of resources is associated with a risk level and a benefit level, and resources in each cohort share the same risk level and the same benefit level;
obtaining a plurality of provider-level adjustments respectively corresponding to a plurality of providers providing the plurality of resources, wherein each provider-level adjustment represents a value by which a total amount of resources from the corresponding provider is allowed to be changed;
constructing an optimization model for determining a resource flow solution represented by a plurality of cohort-provider-level adjustments, wherein:
the plurality of cohort-provider-level adjustments respectively correspond to combinations of the plurality of cohorts and the plurality of providers, and
each cohort-provider-level adjustment represents a value by which resources in the corresponding cohort and provided by the corresponding provider are to be changed according to the resource flow solution; and
according to the plurality of cohort-provider-level adjustments, identifying one or more resources in each of the plurality of cohorts that are provided by a first provider to be transferred to a second provider; and
automatically sending one or more requests to the first provider and the second provider to transfer the identified one or more resources from the first provider to the second provider.

2. The method of claim 1, wherein the method further comprise:
obtaining a global risk distribution and a global benefit distribution, wherein the global risk distribution corresponds to a distribution of the plurality of resources at different risk levels, and the global benefit distribution corresponds to a distribution of the plurality of resources at different benefit levels, and
the optimization model comprises:
an objective function that minimizes a difference between, for each of the plurality of providers, the corresponding provider-level adjustment and a sum of one or more of the plurality of cohort-provider-level adjustments corresponding to the provider;
a first constraint requiring, for a given resource flow solution, a difference between a risk distribution of each provider and the global risk distribution is below a first threshold; and
a second constraint requiring, for a given resource flow solution, a difference between a benefit distribution of each provider and the global benefit distribution is below a second threshold.

3. The method of claim 2, wherein the difference between the risk distribution of each provider and the global risk distribution is determined as a Probability Stability Index (PSI), calculated as
$${\sum }_{m} ( {p}_{jm} - {q}_{m} ) ln \frac{{p}_{jm}}{{q}_{m}} ,$$
where:
m corresponds to a risk level;
j corresponds to an identifier corresponding to a provider;
pⱼₘ corresponds to a ratio of an amount of jₜₕ provider's resources at risk level m to an amount of the jₜₕ provider's total resources;
qₘ corresponds to a ratio of an amount of the plurality of providers' resources at risk level m to an amount of the plurality of resources; and
ln refers to a natural logarithm.

4. The method of claim 2, wherein the first threshold and the second threshold are identical.

5. The method of claim 2, wherein the optimization model further comprises a third constraint that requires each of the plurality of cohort-provider-level adjustments is within a range, and a fourth constraint that requires a total sum of the plurality of cohort-provider-level adjustments is zero.

6. The method of claim 1, wherein the identifying one or more resources in each of the plurality of cohorts that are provided by a first provider to be transferred to a second provider comprises:
identifying one or more first resources in a first cohort and provided by a first provider, wherein a total value of the one or more first resources is not greater than a first value associated with a first cohort-provider-level adjustment corresponding to the first cohort and the first provider; and
identifying a second provider, wherein a total amount of the one or more first resources is not greater than a second value associated with a second cohort-provider-level adjustment corresponding to the first cohort and the second provider.

7. The method of claim 6, wherein the identifying one or more first resources in a first cohort and provided by a first provider comprises:
sorting resources in the first cohort and provided by the first provider;
sequentially selecting a maximum number of the sorted resources with a total resource amount not greater than a first value associated with a first cohort-provider-level adjustment corresponding to the first cohort and the first provider; and
determining the selected resources as the one or more first resources.

8. The method of claim 6, wherein:
the first cohort-provider-level adjustment comprises a negative value, indicating an amount of resources to be transferred out of the first provider; and
the first value is an absolute value of the negative value.

9. The method of claim 6, wherein:
the second cohort-provider-level adjustment comprises a positive value, representing an amount of resources to be transferred to the second provider; and
the second value is equal to the positive value.

10. The method of claim 1, wherein the grouping a plurality of resources into a plurality of cohorts comprises:
grouping the plurality of resources, based on each resource's risk level, into one or more first groups, wherein each of the first groups is associated with a risk level from a set of predetermined risk levels;
grouping the plurality of resources, based on each resource's benefit level, into one or more second groups, wherein each of the second groups is associated with a benefit level from a set of predetermined benefit levels;
generating the plurality of cohorts respectively corresponding to combinations of the set of predetermined risk levels and the set of predetermined benefit level; and
identifying zero or more resources from the plurality of resources to be grouped in each of the plurality of cohorts based on an intersection of the first group associated with the corresponding risk level and the second group associated with the corresponding benefit level.

11. The method of claim 1, wherein the identifying one or more resources in each of the plurality of cohorts that are provided by a first provider to be transferred to a second provider according to the plurality of cohort-provider-level adjustments comprises:
creating a plurality of parallelly executable processing threads respectively corresponding to the plurality of cohorts, wherein each of the parallelly executable processing threads executes instructions to determine a resource distribution strategy to redistribute the resources among providers of resources in the corresponding cohort; and
parallelly executing the plurality of parallelly executable processing threads.

12. The method of claim 11, wherein for each of the plurality of cohorts, the corresponding processing thread performs iterative operations comprising:
dividing the plurality of providers into one or more providing providers and one or more receiving providers according to the plurality of cohort-provider-level adjustments; and
for each of the receiving providers, iterating the providing providers to collect one or more resources in the cohort to transfer from the providing providers to the receiving provider based on cohort-provider-level adjustments associated with the providing providers and the receiving provider.

13. A system for optimizing resource distribution, comprising one or more processors and one or more non-transitory computer-readable memories coupled to the one or more processors and configured with instructions executable by the one or more processors to cause the system to perform operations comprising:
grouping a plurality of resources into a plurality of cohorts, wherein each of the plurality of resources is associated with a risk level and a benefit level, and resources in each cohort share the same risk level and the same benefit level;
obtaining a plurality of provider-level adjustments respectively corresponding to a plurality of providers providing the plurality of resources, wherein each provider-level adjustment represents a value by which a total amount of resources from the corresponding provider is allowed to be changed;
constructing an optimization model for determining a resource flow solution represented by a plurality of cohort-provider-level adjustments, wherein:
the plurality of cohort-provider-level adjustments respectively correspond to combinations of the plurality of cohorts and the plurality of providers, and
each cohort-provider-level adjustment represents a value by which resources in the corresponding cohort and provided by the corresponding provider are to be changed according to the resource flow solution; and
according to the plurality of cohort-provider-level adjustments, identifying one or more resources in each of the plurality of cohorts that are provided by a first provider to be transferred to a second provider; and
automatically sending one or more requests to the first provider and the second provider to transfer the identified one or more resources from the first provider to the second provider.

14. The system of claim 13, wherein the operations further comprise:
obtaining a global risk distribution and a global benefit distribution, wherein the global risk distribution corresponds to a distribution of the plurality of resources at different risk levels, and the global benefit distribution corresponds to a distribution of the plurality of resources at different benefit levels, and
the optimization model comprises:
an objective function that minimizes a difference between, for each of the plurality of providers, the corresponding provider-level adjustment and a sum of one or more of the plurality of cohort-provider-level adjustments corresponding to the provider;
a first constraint requiring, for a given resource flow solution, a difference between a risk distribution of each provider and the global risk distribution is below a first threshold; and
a second constraint requiring, for a given resource flow solution, a difference between a benefit distribution of each provider and the global benefit distribution is below a second threshold.

15. The system of claim 14, wherein the optimization model further comprises a third constraint that requires each of the plurality of cohort-provider-level adjustments is within a range, and a fourth constraint that requires a total sum of the plurality of cohort-provider-level adjustments is zero.

16. The system of claim 13, wherein the identifying one or more resources in each of the plurality of cohorts that are provided by a first provider to be transferred to a second provider comprises:
identifying one or more first resources in a first cohort and provided by a first provider, wherein a total value of the one or more first resources is not greater than a first value associated with a first cohort-provider-level adjustment corresponding to the first cohort and the first provider; and
identifying a second provider, wherein a total amount of the one or more first resources is not greater than a second value associated with a second cohort-provider-level adjustment corresponding to the first cohort and the second provider.

17. A non-transitory computer-readable storage medium configured with instructions executable by one or more processors to cause the one or more processors to perform operations comprising:
grouping a plurality of resources into a plurality of cohorts, wherein each of the plurality of resources is associated with a risk level and a benefit level, and resources in each cohort share the same risk level and the same benefit level;
obtaining a plurality of provider-level adjustments respectively corresponding to a plurality of providers providing the plurality of resources, wherein each provider-level adjustment represents a value by which a total amount of resources from the corresponding provider is allowed to be changed;
constructing an optimization model for determining a resource flow solution represented by a plurality of cohort-provider-level adjustments, wherein:
the plurality of cohort-provider-level adjustments respectively correspond to combinations of the plurality of cohorts and the plurality of providers, and
each cohort-provider-level adjustment represents a value by which resources in the corresponding cohort and provided by the corresponding provider are to be changed according to the resource flow solution; and
according to the plurality of cohort-provider-level adjustments, identifying one or more resources in each of the plurality of cohorts that are provided by a first provider to be transferred to a second provider; and
automatically sending one or more requests to the first provider and the second provider to transfer the identified one or more resources from the first provider to the second provider.

18. The non-transitory computer-readable storage medium of claim 17, wherein the operations further comprise:
obtaining a global risk distribution and a global benefit distribution, wherein the global risk distribution corresponds to a distribution of the plurality of resources at different risk levels, and the global benefit distribution corresponds to a distribution of the plurality of resources at different benefit levels, and
the optimization model comprises:
an objective function that minimizes a difference between, for each of the plurality of providers, the corresponding provider-level adjustment and a sum of one or more of the plurality of cohort-provider-level adjustments corresponding to the provider;
a first constraint requiring, for a given resource flow solution, a difference between a risk distribution of each provider and the global risk distribution is below a first threshold; and
a second constraint requiring, for a given resource flow solution, a difference between a benefit distribution of each provider and the global benefit distribution is below a second threshold.

19. The non-transitory computer-readable storage medium of claim 17, wherein the grouping a plurality of resources into a plurality of cohorts comprises:
grouping the plurality of resources, based on each resource's risk level, into one or more first groups, wherein each of the first groups is associated with a risk level from a set of predetermined risk levels;
grouping the plurality of resources, based on each resource's benefit level, into one or more second groups, wherein each of the second groups is associated with a benefit level from a set of predetermined benefit levels;
generating the plurality of cohorts respectively corresponding to combinations of the set of predetermined risk levels and the set of predetermined benefit level; and
identifying zero or more resources from the plurality of resources to be grouped in each of the plurality of cohorts based on an intersection of the first group associated with the corresponding risk level and the second group associated with the corresponding benefit level.

20. The non-transitory computer-readable storage medium of claim 17, wherein the identifying one or more resources in each of the plurality of cohorts that are provided by a first provider to be transferred to a second provider according to the plurality of cohort-provider-level adjustments comprises:
creating a plurality of parallelly executable processing threads respectively corresponding to the plurality of cohorts, wherein each of the parallelly executable processing threads executes instructions to determine a resource distribution strategy to redistribute the resources among providers of resources in the corresponding cohort; and
parallelly executing the plurality of parallelly executable processing threads.
